(19) United States
(12) Patent Application Publication
(10) Pub. No.: US 2013/0229023 A1
(43) Pub. Date: Sep. 5, 2013

(54) DOOR JAMB SECURITY FEATURE

(71) Applicant: Noubar Yeremian, Radnor, PA (US)

(72) Inventor: Noubar Yeremian, Radnor, PA (US)

(21) Appl. No.: 13/785,353

(22) Filed: Mar. 5, 2013

Related U.S. Application Data
(60) Provisional application No. 61/606,752, filed on Mar. 5, 2012.

(51) Int. Cl. E05B 15/02

(52) U.S. Cl. CPC E05B 15/0205
USPC 292/341.14

(57) ABSTRACT

A protective cover for the lock-side of a door jamb is disclosed having a cover with a height that is less than or equal to the height of the door jamb. The cover includes a main portion and a first and second wall extending therefrom. The main portion is perpendicular to the first and second walls, and the first and second walls are parallel to each other. The apparatus also includes at least one backup plate recessed from a face of the main portion having a hole that is configured to receive a door latch or dead bolt. In the installed condition, the main portion and the first wall rests against and in contact with the vertical lockside portion of the door jamb, and the second wall is inserted into the vertical lockside portion of the door jamb.

### CROSS-REFERENCE TO RELATED APPLICATIONS

This application claims priority of U.S. Provisional Application No. 61/606,752, filed Mar. 5, 2012, the disclosure of which is incorporated herein by reference in its entirety for all purposes.

### FIELD OF THE INVENTION

The invention relates to a security feature for a door jamb to prevent forced entry.

### BACKGROUND OF THE INVENTION

Door-jambs are typically made of wood; however, wood is not resistant to forced entries that occur during burglaries or acts of vandalism when a tool is used to bend or destroy the area around a door latch. Current door-jambs use a small, generally flat metal plate around the immediate perimeter of the hole in the door jamb which receives a latch or dead bolt; however, the metal plates, known as strike plates, may bend and fail. Therefore, strike plates are also unlikely to provide sufficient resistance to forced entries.

There is therefore a need for improved security features to prevent forced entry through a doorway.

### SUMMARY OF THE INVENTION

According to one embodiment of the present invention, an apparatus which provides added security to an entryway is disclosed. The apparatus is affixed to a vertical lockside portion of a door jamb. The apparatus comprises a cover having a height that is less than or equal to the height of the door jamb. The cover includes a main portion having a first end and a second end, a first wall extending from the first end, and a second wall extending from the second end. The main portion is perpendicular to the first and second walls, and the first and second walls are parallel to each other. The apparatus also includes at least one backup plate recessed from a face of the main portion having a hole that is configured to receive a door latch or dead bolt. In the installed condition, the main portion and the first wall rests against and in contact with the vertical lockside portion of the door jamb and the second wall is inserted into the vertical lockside portion of the door jamb.

### BRIEF DESCRIPTION OF THE DRAWINGS

In order that the invention may be more fully understood, the following figures are provided by way of illustration, in which:

FIG. 1 is an exploded view of a cover according to an embodiment of the present invention and a vertical lock-side portion of a door jamb on which the cover is applied.

FIG. 2 is a top view of the cover illustrated in FIG. 1.

FIG. 3 is a top view of the vertical lock-side portion of the door jamb illustrated in FIG. 1.

FIG. 4 is a top view of the cover illustrated in FIG. 1 applied to the vertical lock-side portion of the door jamb illustrated in FIG. 1.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention provides improved security to a doorway by reinforcing the lock-side of a door jamb.

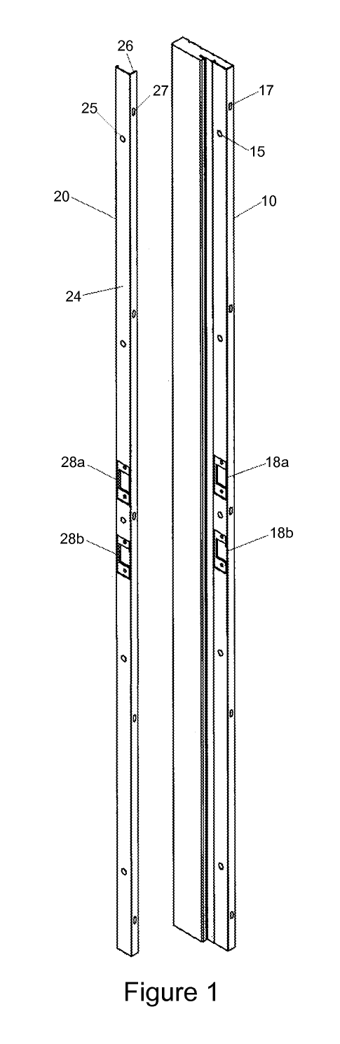

According to a preferred embodiment of the present invention, a cover 20 and the vertical lock-side portion of a door jamb 10 to which the cover 20 is applied is illustrated in FIG. 1. The cover 20 provides adequate protective covering to resist the forced entry through a doorway.

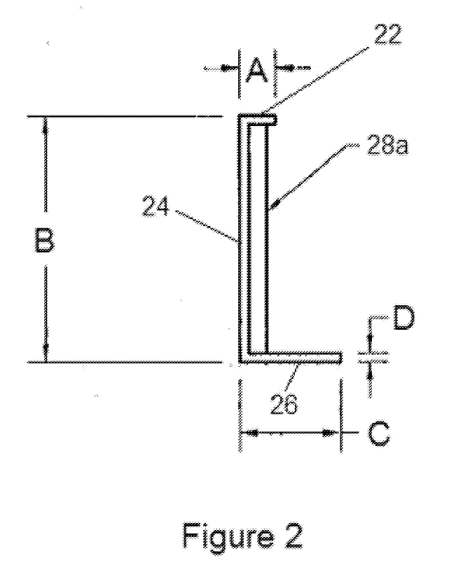

Referring to FIG. 2, the cover 20, according to one embodiment of the invention, preferably comprises three sections: Two generally parallel walls (22, 26) and a main portion 24 that is generally perpendicular to the two parallel walls (22, 26). Preferably, one of each of the two parallel walls (22, 26) independently extends from one end of the main portion 24. The two parallel walls (22, 26) extend in the same direction from main portion 24. The cover 20 may be made of any suitable material of a suitable thickness D which will resist forced warping by a tool, and is preferably made of 16 gauge stainless steel. Preferably, the thickness D of the cover 20 is preferably uniform. The configuration of the embodiment illustrated in FIG. 2 results in two 90 degree bends. The cover 20, instead of having a two parallel walls, may include a single wall which is perpendicular to the main portion; however, incorporating multiple 90 degree bends, improves the ability of the cover to resist bending along its length.

In the embodiment of the invention illustrated in FIG. 4, the cover 20 is in the installed condition on the vertical portion of a lockside door jamb 10. Of the two parallel walls, a first wall 22 is located on the side of the cover 20 closest to the doorstop 12. Referring again to FIG. 2, the first wall 22 has a width A. A second wall 26 is in opposing relation to the first wall 22 and has a width C. The first width A of the first wall 22 may be equal to the second width C of the second wall 26; however, it is preferred that the first width A is less than the second width C providing the cover 20 with a J-shaped cross-section. The first width A is preferably less than a thickness I of the portion 14 of the lockside door jamb 10 on which the cover 10 is applied, but should not be so short that the intended 90 degree bend between the main portion 24 and first wall 22 does not impart any added strength so that the cover 20 will resist bending along its length.

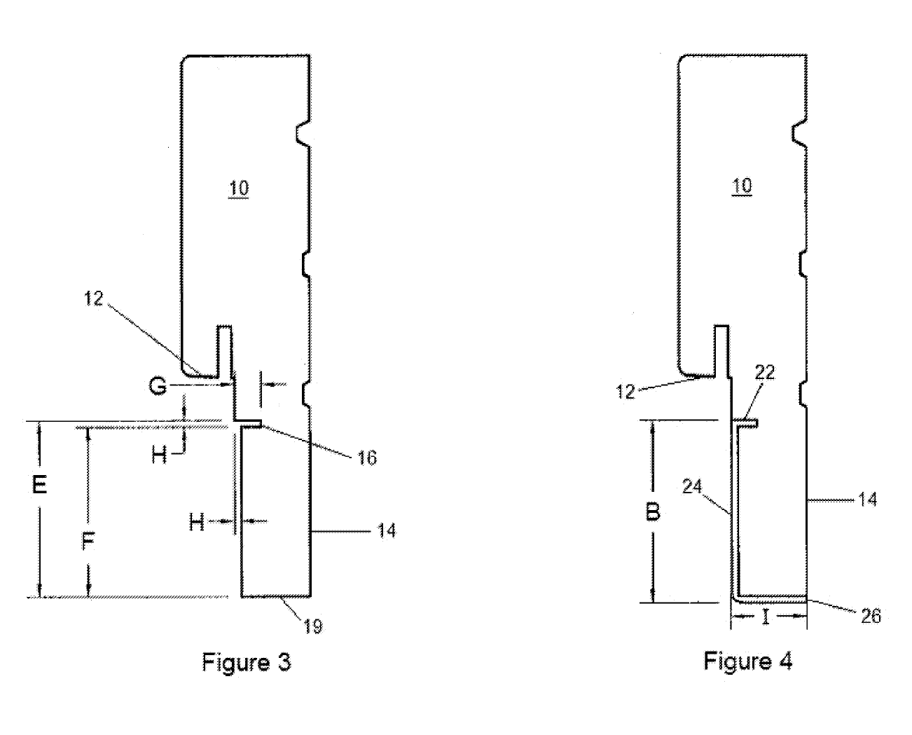

Referring to FIGS. 3 and 4, the portion 14 of the lockside door jamb 10 includes a groove 16 in which the first wall 22 of the cover 20 is inserted. The thickness H of the groove 16 is preferably equal to the thickness D of the first wall 22. The depth G of the groove 16 is preferably equal to the width A of the first wall 22, so that the main portion 24 of the cover 20 rests against the lockside door jamb 10, and the cover 20 will not interfere with the closing of the door (not shown) hung in the door jamb. It is also preferred that the groove 16 is located a distance E from the end 19 of the lockside jamb 10, such that the second wall 26 rests against the end 19 of the lockside jamb 10. Therefore, the distance E is preferably equal to the width B of the main portion 24 of the cover 20 less the thickness of the second wall 26.

The cover of the present invention may be affixed to the lockside jamb according to any method known to those of skill in the art. The embodiment of the invention illustrated in FIG. 1 preferably includes a plurality of holes (25, 27) in the main portion 24 and second wall 26 of the cover 20. The holes are preferably in the form of countersink mounting holes, so that the cover may be attached to the lockside jamb with fasteners such as bugle-head screws to prevent the heads of the screws from protruding from the surface of the wall in which they are inserted. The holes may be placed along the main portion 24 and second wall 26 of the cover 20, such that the holes will align with corresponding pre-drilled holes (15, 17) in the lockside jamb 10.

The present invention also includes at least one opening through which a door latch or dead bolt may be actuated. The openings are preferably located within a recessed backup plate. Referring to the embodiment of the invention illustrated FIG. 1, two recessed backup plates (28a, 28b) are each independently located at a height in the main portion 24 of the cover 20. The backup plates (28a, 28b) are integral to the main portion 24 and are recessed, so that strike plates (not shown) may be inserted into the recesses and will not protrude beyond the face of the main portion 24. Strike plates are often provided by manufacturers with a deadbolt and/or door latch set. Therefore, the recessed backup plates in the covers according to the present invention should accommodate various sizes and shaped strike plates should it be necessary to change the latch or dead bolt associated with a door that is hung in the door jamb. The lockside jamb 10 preferably includes corresponding cutouts (18a, 18b) that will align and receive the backup plates (28a, 28b) when the cover 20 is installed.

It is preferred that the length of the cover spans the entire height of the lockside door jamb; however, the cover may be shorter if such a dimension is found to be effective at resisting forced entries. For example, it may be acceptable for a cover according to the present invention to have a height approximately equal to or slightly longer that the length spanning the one or more openings in which the backup plates are located. Also, the width of the cover, such as the dimension B of the main portion 24 illustrated in FIG. 2, may be greater than or equal to the width of the backup plates in the cover. Preferably, the width of the cover is about equal to the width of the backup plate, more preferably with a tolerance of ±0.01″, and most preferably within a tolerance of ±0.005″. Selecting the dimensions in such a way would be more cost-effective as the dimensions would be minimized and less material is needed to fabricate the cover.

As used herein throughout the specification and claims, the phrase “about equal” means within a tolerance of 0.25″.

While a preferred embodiment of the invention has been shown and described herein, it will be understood that such embodiment is provided by way of example only. Numerous variations, changes, and substitutions will occur to those skilled in the art without departing from the spirit of the invention. Accordingly, it is intended that the appended claims cover all such variations as fall within the spirit and scope of the invention.

What is claimed:

1. An entryway security apparatus capable of being mounted on a vertical lockside portion of a door jamb, the apparatus comprising:
a cover including a main portion having a first end and a second end, a first wall extending from the first end, the main portion being perpendicular to the first wall; and
at least one backup plate recessed from a face of the main portion, the backup plate having a hole that is configured to receive a door latch or dead bolt,
wherein the cover is configured such that in the installed condition the main portion and the first wall rests against and in contact with the vertical lockside portion of the door jamb.

2. The apparatus of claim 1, wherein the main portion has a width that is about equal to the width of the backup plate.

3. The apparatus of claim 1, wherein the cover has a height that is less than or equal to the height of the door jamb and greater than or equal to the height of the backup plate.

4. The apparatus of claim 1 further comprising two backup plates.

5. The apparatus of claim 1 further comprising a second wall extending from the second end of the main portion, the second wall being perpendicular to the main portion and parallel to the first wall,
wherein in the installed condition, the second wall is inserted into the vertical lockside portion of the door jamb.

6. The apparatus of claim 5, wherein the first wall extends a first distance from the main portion, the second wall extends a second distance from the main portion, and the second distance is less than the first distance.

7. The apparatus of claim 5, wherein the main portion has a width that is about equal to the width of the backup plate.

8. The apparatus of claim 5 further comprising two backup plates.

9. An entryway security apparatus capable of being mounted on a vertical lockside portion of a door jamb, the apparatus comprising:
a cover including a main portion having a first end and a second end, a first wall extending from the first end, the main portion being perpendicular to the first wall; and
at least one backup plate recessed from a face of the main portion, the backup plate having a hole that is configured to receive a door latch or dead bolt,
wherein the cover is configured such that in the installed condition the main portion rests against and in contact with the vertical lockside portion of the door jamb, and the first wall is inserted into the vertical lockside portion of the door jamb.

10. The apparatus of claim 9, wherein the main portion has a width that is about equal to the width of the backup plate.

11. The apparatus of claim 9, wherein the cover has a height that is less than or equal to the height of the door jamb and greater than or equal to the height of the backup plate.

12. The apparatus of claim 9 further comprising two backup plates.
